(19) United States
(12) Patent Application Publication
(10) Pub. No.: US 2025/0172788 A1
(43) Pub. Date: May 29, 2025

(54) OPTICAL IMAGING SYSTEM

(71) Applicant: Samsung Electro-Mechanics Co., Ltd., Suwon-si (KR)

(72) Inventors: Tae Yeon LIM, Suwon-si (KR); Byung Hyun KIM, Suwon-si (KR); Yong Joo JO, Suwon-si (KR); Se Hun KIM, Suwon-si (KR)

(73) Assignee: Samsung Electro-Mechanics Co., Ltd., Suwon-si (KR)

(21) Appl. No.: 18/941,274

(22) Filed: Nov. 8, 2024

(30) Foreign Application Priority Data
Nov. 24, 2023 (KR) 10-2023-0165147
Jun. 27, 2024 (KR) 10-2024-0084489

(51) Int. Cl. G02B 13/00; G02B 9/62

(52) U.S. Cl. CPC G02B 13/0045; G02B 9/62; G02B 13/0065

(57) ABSTRACT

An optical imaging system includes a first lens group having a positive refractive power and including at least one lens; a second lens group including a plurality of lenses; and a reflective member disposed between the first lens group and the second lens group and including a reflective surface, wherein the first lens group and the reflective member are configured to be rotatable together around two axes perpendicular to an optical axis of the first lens group and perpendicular to each other, and the optical imaging system satisfies 1.3<f/fG1<1.8, where f is a total focal length of the optical imaging system, and fG1 is a focal length of the first lens group.

### CROSS-REFERENCE TO RELATED APPLICATIONS

This application claims the benefit under 35 USC 119 (a) of Korean Patent Application Nos. 10-2023-0165147 filed on Nov. 24, 2023, and 10-2024-0084489 filed on Jun. 27, 2024, in the Korean Intellectual Property Office, the entire disclosures of which are incorporated herein by reference for all purposes.

### BACKGROUND

### 1. Field

The present disclosure relates to an optical imaging system.

### 2. Description of Related Art

Recently, a camera module in which a reflective member is disposed in front of an optical imaging system to change a path of light has been adopted for use in a portable electronic device.

This method has a limitation in increasing a diameter of a lens of the optical imaging system because the diameter of the lens affects a thickness of the portable electronic device. Therefore, there may be a problem that it may be difficult to reduce an F-number of the optical imaging system.

Accordingly, a structure in which a portion of lenses of an optical imaging system is disposed in front of a reflective member has been proposed.

Meanwhile, in order to increase resolution, a camera module including an optical imaging system has an autofocus adjusting function that corrects shake during image capturing. This autofocus adjusting function may be implemented through two-axis rotation of a reflective member. In this case, the two-axis rotation may be implemented through pitch rotation and yaw rotation. In addition, when a lens is disposed in front of the reflective member, the lens may rotate together with the reflective member.

In this case, a pitch rotation axis and a yaw rotation axis are two axes perpendicular to an optical axis of lenses arranged behind the reflective member and perpendicular to each other.

For example, rotation around a yaw axis may be implemented by rotating the reflective member around a direction in which light is incident on the reflective member as a rotation axis, and rotation around a pitch axis may be implemented by rotating the reflective member around an axis perpendicular to both the yaw axis and the optical axis of the lenses arranged behind the reflective member as a rotation axis.

In this case, when the reflective member rotates in a yaw rotation manner, an error may occur as a change of an intended optical path length.

In yaw rotation, among two-axis rotations, a lens disposed in front of the reflective member does not have a change in an apparent position significantly before and after the yaw rotation.

Therefore, when performing autofocus adjusting in the yaw direction, there may be a problem that aberration occurs significantly during the autofocus adjusting, thereby reducing a resolution.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens group having a positive refractive power and including at least one lens; a second lens group including a plurality of lenses; and a reflective member disposed between the first lens group and the second lens group and including a reflective surface, wherein the first lens group and the reflective member are configured to be rotatable together around two axes perpendicular to an optical axis of the first lens group and perpendicular to each other, and the optical imaging system satisfies 1.3<f/fG1<1.8, where f is a total focal length of the optical imaging system, and fG1 is a focal length of the first lens group.

The optical imaging system may further satisfy 0.07 [1/mm]≤PG1<0.1 [1/mm], where PG1 is a reciprocal of the focal length of the first lens group.

The optical imaging system may further satisfy 0.6<Lr/f<0.8, where Lr is a distance along an optical axis of the optical imaging system from the reflective surface to an image plane of the optical imaging system.

The optical imaging system may further satisfy 0.3<Lf/Lr<0.6, where Lf is a distance along an optical axis of the optical imaging system from an object-side surface of a lens closest to an object side of the optical imaging system among the at least one lens of the first lens group to the reflective surface, and Lr is a distance along the optical axis from the reflective surface to an image plane of the optical imaging system.

The optical imaging system may further satisfy satisfying 0.6<Lr/TTL<0.8, where Lr is a distance along an optical axis of the optical imaging system from the reflective surface to an image plane of the optical imaging system, and TTL is a sum of a distance along the optical axis from an object-side surface of a lens closest to an object side of the optical imaging system among the at least one lens of the first lens group to the reflective surface, and a distance along the optical axis from the reflective surface to the image plane.

The optical imaging system may further satisfy 0.2<BFL/TTL<0.5, where BFL is a distance along an optical axis of the optical imaging system from an image-side surface of a lens closest to an image plane of the optical imaging system among the plurality of lenses of the second lens group to the image plane, and TTL is a sum of a distance along the optical axis from an object-side surface of a lens closest to an object side of the optical imaging system among the at least one lens of the first lens group to the reflective surface, and a distance along the optical axis from the reflective surface to the image plane.

The optical imaging system may further satisfy 0<DG2/TTL<0.2, where DG2 is a distance along an optical axis of the optical imaging system from an object-side surface of a lens closest to the reflective member among the plurality of lenses of the second lens group to an image-side surface of a lens closest to an image plane of the optical imaging system among the plurality of lenses of the second lens group, and TTL is a sum of a distance along the optical axis from an object-side surface of a lens closest to an object side of the optical imaging system among the at least one lens of the first lens group to the reflective surface, and a distance along the optical axis from the reflective surface to the image plane.

The optical imaging system may further satisfy 0.3<CA_G21/CA_G11<0.6, where CA_G21 is an effective diameter of an object-side surface of a lens closest to the reflective member among the plurality of lenses of the second lens group, and CA_G11 is an effective diameter of an object-side surface of a lens closest to an object side of the optical imaging system among the at least one lens of the first lens group.

The optical imaging system may further satisfy 2.8<f/CA_G11<3.2, where CA_G11 is an effective diameter of an object-side surface of a lens closest to an object side of the optical imaging system among the at least one lens of the first lens group.

The optical imaging system may further satisfy 0.4<|fG1/fG2|<1, where fG2 is a focal length of the second lens group.

The second lens group may have a negative refractive power.

The optical imaging system may further satisfy −1.4<f/fG2<−0.6, where fG2 is a focal length of the second lens group.

The optical imaging system may further satisfy 0.2<RG1_S1/fG1<0.6, where RG1_S1 is a radius of curvature of an object-side surface of a lens closest to an object side of the optical imaging system among the at least one lens of the first lens group.

The optical imaging system may further satisfy 0.5<fG1/TTL<0.9, where TTL is a sum of a distance along an optical axis of the optical imaging system from an object-side surface of a lens closest to an object side of the optical imaging system among the at least one lens of the first lens group to the reflective surface, and a distance along the optical axis from the reflective surface to an image plane of the optical imaging system.

The at least one lens of the first lens group may include a first lens and a second lens, and at least one lens among the first lens and the second lens may have a refractive index greater than 1.6, a convex object-side surface in a paraxial region thereof, and a concave image-side surface in a paraxial region thereof.

The first lens may have a positive refractive power and a refractive index less than 1.55, and the second lens may have a negative refractive power.

A lens closest to an image plane of the optical imaging system among the plurality of lenses of the second lens group may have a positive refractive power and a refractive index greater than 1.6, and at least one other lens among the plurality of lenses of the second lens group, other than the lens closest to the image plane among the plurality of lenses of the second lens groups, may have a refractive index greater than 1.6.

In another general aspect, an optical imaging system includes a first lens group having a positive refractive power and including at least one lens; a second lens group including a plurality of lenses; and a reflective member disposed between the first lens group and the second lens group and including a reflective surface, wherein the first lens group and the reflective member are configured to be rotatable together around two axes perpendicular to an optical axis of the first lens group and perpendicular to each other, and the optical imaging system satisfies 0.2<BFL/TTL<0.5, where BFL is a distance along an optical axis of the optical imaging system from an image-side surface of a lens closest to an image plane of the optical imaging system among the plurality of lenses of the second lens group to the image plane, and TTL is a sum of a distance along the optical axis from an object-side surface of a lens closest to an object side of the optical imaging system among the at least one lens of the first lens group to the reflective surface, and a distance along the optical axis from the reflective surface to the image plane.

The optical imaging system may further satisfy 0.4<|fG1/fG2|<1, where fG1 is a focal length of the first lens group, and fG2 is a focal length of the second lens group.

The optical imaging system may further satisfy 0.3<Lf/Lr<0.6, where Lf is a distance along an optical axis of the optical imaging system from an object-side surface of a lens closest to an object side of the optical imaging system among the at least one lens of the first lens group to the reflective surface, and Lr is a distance along the optical axis from the reflective surface to an image plane of the optical imaging system.

The optical imaging system may further satisfy 0.5<fG1/TTL<0.9, where fG1 is a focal length of the first lens group.

In another general aspect, an optical imaging system includes a first lens group having a positive refractive power and including at least one lens; a second lens group including a plurality of lenses; and a reflective member disposed between the first lens group and the second lens group and including a reflective surface, wherein the first lens group and the reflective member are configured to be rotatable together around two axes perpendicular to an optical axis of the first lens group and perpendicular to each other, and the optical imaging system satisfies 0.3<CA_G21/CA_G11<0.6, where CA_G21 is an effective diameter of an object-side surface of a lens closest to the reflective member among the plurality of lenses of the second lens group, and CA_G11 is an effective diameter of an object-side surface of a lens closest to an object side of the optical imaging system among the at least one lens of the first lens group.

The optical imaging system may further satisfy 0.07 [1/mm]≤PG1<0.1 [1/mm], where PG1 is a reciprocal of a focal length of the first lens group.

The optical imaging system may further satisfy 0.2<RG1_S1/fG1<0.6, where RG1_S1 is a radius of curvature of the object-side surface of the lens closest to the object side of the optical imaging system among the at least one lens of the first lens group, and fG1 is a focal length of the first lens group.

The optical imaging system may further satisfy 2.8<f/CA_G11<3.2, where f is a total focal length of the optical imaging system.

Other features and aspects will be apparent from the following detailed description, the drawings, and the claims.

### BRIEF DESCRIPTION OF DRAWINGS

FIG. 1 is a configuration diagram of an optical imaging system according to a first embodiment of the present disclosure.

FIG. 2 is a configuration diagram of an optical imaging system according to a second embodiment of the present disclosure.

FIG. 3 is a configuration diagram of an optical imaging system according to a third embodiment of the present disclosure.

FIG. 4 is a configuration diagram of an optical imaging system according to a fourth embodiment of the present disclosure.

FIG. 5 is a configuration diagram of an optical imaging system according to a fifth embodiment of the present disclosure.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the lens configuration diagrams in the drawings, a thickness, a size, and a shape of a lens may be somewhat exaggerated for explanation, and in particular, a spherical shape or an aspherical shape shown in the lens configuration diagrams is only illustrative, and is not limited to this shape.

An optical imaging system according to an embodiment of the present disclosure may be mounted on a portable electronic device. For example, the optical imaging system may be a component of a camera module mounted on the portable electronic device. The portable electronic device may be a mobile communication terminal, a smartphone, a tablet PC, or other portable device.

In this specification, a radius of curvature, a thickness, a distance, and a focal length of a lens and other measurements are expressed in mm, and an angle of view is expressed in degrees. Thicknesses and distances are measured along an optical axis of the optical imaging system.

Unless stated otherwise, a reference to a shape of a lens surface refers to a shape of a paraxial region of the lens surface. A paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid.

For example, a statement that an object-side surface of a lens is convex means that at least a paraxial region of the object-side surface of the lens is convex, and a statement that an image-side surface of the lens is concave means that at least a paraxial region of the image-side surface of the lens is concave. Therefore, even though the object-side surface of the lens may be described as being convex, the entire object-side surface of the lens may not be convex, and a peripheral region of the object-side surface of the lens may be concave. Also, even though the image-side surface of the lens may be described as being concave, the entire image-side surface of the lens may not be concave, and a peripheral region of the image-side surface of the lens may be convex.

An image plane may be a virtual surface on which an image is focused by the optical imaging system. Alternatively, the image plane may be a surface of an image sensor on which light is incident.

An optical imaging system according to an embodiment of the present disclosure may include a plurality of lens groups. For example, the optical imaging system may include a first lens group and a second lens group. The first lens group may include at least one lens, and the second lens group may include a plurality of lenses.

In an embodiment, the first lens group may include a first lens, a second lens, and a third lens, and the second lens group may include a fourth lens, a fifth lens, and a sixth lens. The first to sixth lenses may be sequentially arranged in ascending numerical order from an object side of the optical imaging system toward an image plane of the optical imaging system.

In an embodiment, the first lens group may include a first lens and a second lens, and the second lens group may include a third lens, a fourth lens, and a fifth lens. The first to fifth lenses may be sequentially arranged in ascending numerical order from an object side of the optical imaging system toward an image plane of the optical imaging system.

In an embodiment, the first lens group may include a first lens and a second lens, and the second lens group may include a third lens, a fourth lens, a fifth lens, and a sixth lens. The first to sixth lenses may be sequentially arranged in ascending numerical order from an object side of the optical imaging system toward an image plane of the optical imaging system.

The plurality of lenses included in the optical imaging system may be spaced apart from each other in an optical axis direction.

An optical imaging system according to an embodiment of the present disclosure may further include a reflective member having a reflective surface that changes a propagation direction of light. For example, the reflective member may be a mirror or a prism. In an embodiment, the reflective member may be disposed between the first lens group and the second lens group.

When the reflective member is a prism, the reflective member may have a shape in which a cuboid shape or a cubic shape is divided diagonally into two halves. The reflective member may include an incident surface, a reflective surface, and an exit surface. The reflective member may include three rectangular surfaces and two triangular surfaces. For example, the incident surface, the reflective surface, and the exit surface of the reflective member may be each rectangular, and both side surfaces of the reflective member may be approximately triangular.

Light passing through the first lens group may be incident on the incident surface of the reflective member, light incident on the incident surface may be reflected on the reflective surface, and light reflected on the reflective surface may be emitted to the exit surface.

An optical axis of the first lens group and an optical axis of the second lens group may intersect each other. For example, a virtual line extending the optical axis of the first lens group and a virtual line extending the optical axis of the second lens group may intersect each other.

In an embodiment, the optical axis of the first lens group and the optical axis of the second lens group may be perpendicular to each other.

Light may be bent by the reflective member to form a long optical path in a relatively narrow space.

Therefore, the optical imaging system may be miniaturized while allowing the optical imaging system to have a long focal length.

An optical imaging system according to an embodiment of the present disclosure may have characteristics of a telephoto lens having a relatively narrow angle of view and a long focal length.

In addition, the optical imaging system may further include an image sensor for converting an image of a subject incident the image sensor into an electric signal.

In addition, the optical imaging system may further include an infrared blocking filter (hereinafter referred to as a filter) for blocking infrared rays. The filter may be disposed between a rearmost lens (e.g., the fifth lens or the sixth lens) and the image sensor.

The first lens group may have a positive refractive power as a whole, and may include at least one lens having a meniscus shape convex toward an object side.

The first lens group may include at least one lens having a refractive index exceeding 1.6. Among lenses included in the first lens group, a lens having a refractive index exceeding 1.6 may have a meniscus shape convex toward an object side.

In an embodiment, a second lens may have a refractive index exceeding 1.6 and a meniscus shape convex toward an object side. The second lens may have a negative refractive power. A first lens may have a positive refractive power and a refractive index smaller than the refractive index of the second lens. For example, the refractive index of the first lens may be smaller than 1.55.

An effective diameter of an object-side surface and an effective diameter of an image-side surface of each lens of the at least one lens included in the first lens group may be greater than a length of a minor axis of the incident surface of the reflective member.

Each lens of the at least one lens included in the first lens group may be approximately circular when viewed in an optical axis direction of the first lens group.

Each lens of the at least one lens included in the first lens group may be made of a plastic material.

The second lens group may have a negative refractive power as a whole.

The second lens group may include at least two lenses having a refractive index exceeding 1.6. In an embodiment, a lens of the second lens group closest to the image sensor may have a refractive index exceeding 1.6. The lens of the second lens group closest to the image sensor may have a positive refractive power.

In an embodiment, at least two lenses of the second lens group, including a lens of the second lens group closest to the image sensor, may have a refractive index exceeding 1.6.

The lenses included in the second lens group may be approximately non-circular when viewed in an optical axis direction of the second lens group.

The lenses included in the second lens group may have different dimensions in two directions perpendicular to the optical axis direction of the second lens group and perpendicular to each other.

The lenses included in the second lens group may be made of a plastic material.

The reflective member may be disposed in front of the second lens group. To correct shake during image capturing, the reflective member may rotate around two axes.

For example, when shaking occurs due to factors such as shaking of a user's hand or other disturbances in capturing an image or a video, the reflective member rotates in response to the shaking, thereby compensating for the shaking.

The reflective member may rotate around two axes perpendicular to the optical axis of the first lens group and perpendicular to each other as rotation axes.

In an embodiment, the reflective member may rotate around an axis perpendicular to both the optical axis of the first lens group and the optical axis of the second lens group (or an axis parallel thereto) as a rotation axis (a pitch rotation axis), and may rotate around the optical axis of the second lens group (or an axis parallel to the optical axis of the second lens group) as a rotation axis (a roll rotation axis).

Since the first lens group having a positive refractive power is disposed in front of the reflective member, light incident on the reflective member may be converged, and therefore a diameter of the second lens group may be configured to be small. Therefore, a height of the optical imaging system may be reduced while reducing an Fno (F number, f-number) of the optical imaging system.

In addition, the first lens group may rotate together with the reflective member. In this case, since the first lens group and the reflective member may rotate in a pitch and roll rotation manner, aberrations that occur during autofocus adjusting may be reduced. In addition, a refractive power (power) of the first lens group may be designed to be relatively strong, to reduce a height of the second lens group.

In an embodiment, at least one lens included in the first lens group and a plurality of lenses included in the second lens group may have aspheric surfaces on an object-side surface and an image-side surface thereof.

An aspheric surface of a lens may be expressed by Equation 1 below.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} \qquad ( 1 )$$

In Equation 1, c is a curvature of the lens surface and is equal to a reciprocal of a radius of curvature of the lens surface at an optical axis of the lens surface, K is a conic constant, and Y is a distance from any point on the aspherical surface of the lens to the optical axis. In addition, constants A to H, J, and L are aspherical surface coefficients. Z (also known as sag) is a distance in a direction parallel to an optical axis direction between the point on the aspherical surface of the lens at the distance Y from the optical axis of the aspherical surface to a tangential plane perpendicular to the optical axis and intersecting a vertex of the aspherical surface.

An optical imaging system according to an embodiment of the present disclosure may satisfy any one or any combination of any two or more of Conditional Expressions 1 to 13 below.

$$0.07 [ 1 / mm ] \leq PG 1 < 0.1 [ 1 / mm ] \qquad ( Conditional Expression 1 )$$

$$1.3 < f / fG 1 < 1.8 \qquad ( Conditional Expression 2 )$$

$$0.6 < Lr / f < 0.8 \qquad ( Conditional Expression 3 )$$

$$0.6 < Lr / TTL < 0.8 \qquad ( Conditional Expression 4 )$$

$$0.3 < CA\_G21 / CA\_G11 < 0.6 \qquad ( Conditional Expression 5 )$$

$$0.2 < BFL / TTL < 0.5 \qquad ( Conditional Expression 6 )$$

$$0.4 < \vert fG 1 / fG 2 \vert < 1 \qquad ( Conditional Expression 7 )$$

$$- 1.4 < f / fG 2 < - 0.6 \qquad ( Conditional Expression 8 )$$

$$0.2 < RG1\_S1 / fG 1 < 0.6 \qquad ( Conditional Expression 9 )$$

$$0.3 < Lf / Lr < 0.6 \qquad ( Conditional Expression 10 )$$

$$0 < DG 2 / TTL < 0.2 \qquad ( Conditional Expression 11 )$$

$$0.5 < fG 1 / TTL < 0.9 \qquad ( Conditional Expression 12 )$$

$$2.8 < f / CA\_G11 < 3.2 \qquad ( Conditional Expression 13 )$$

In an embodiment, an optical imaging system may satisfy 0.07 [1/mm]≤PG1<0.1 [1/mm] (Conditional Expression 1). In this case, PG1 is a reciprocal of a focal length of a first lens group. Therefore, the focal length of the first lens group may be optimized to reduce a size of a reflective member and a size of a second lens group.

In an embodiment, an optical imaging system may satisfy 1.3<f/fG1<1.8 (Conditional Expression 2). In this case, f is a total focal length of the optical imaging system, and fG1 is a focal length of a first lens group. Therefore, the focal length of the first lens group having a positive refractive power may be optimized to reduce diameters of lenses included in a second lens group.

In an embodiment, an optical imaging system may satisfy 0.6<Lr/f<0.8 (Conditional Expression 3). In this case, Lr is a distance along an optical axis of the optical imaging system from a reflective surface of a reflective member to an image plane. Therefore, the optical imaging system may be miniaturized.

In an embodiment, an optical imaging system may satisfy 0.6<Lr/TTL<0.8 (Conditional Expression 4). In this case, TTL is a sum of a distance along the optical axis of the optical imaging system from an object-side surface of a first lens of a first lens group to a reflective surface of a reflective member, and a distance along the optical axis of the optical imaging system from the reflective surface of the reflective member to an image plane. Therefore, the optical imaging system may be miniaturized.

In an embodiment, an optical imaging system may satisfy 0.3<CA_G21/CA_G11<0.6 (Conditional Expression 5). In this case, CA_G21 is an effective diameter of an object-side surface of a first lens of a second lens group (e.g., a third lens or a fourth lens), and CA_G11 is an effective diameter of an object-side surface of a first lens of a first lens group. When the first lens of the second lens group is a non-circular lens, CA_G21 is a maximum effective diameter of the first lens of the second lens group. Therefore, an image brightness may be improved, and the optical imaging system may be miniaturized.

In an embodiment, an optical imaging system may satisfy 0.2<BFL/TTL<0.5 (Conditional Expression 6). In this case, BFL is a distance along the optical axis of the optical imaging system from an image-side surface of a last lens of a second lens group (e.g., a fifth lens or a sixth lens) to an image plane. Therefore, the optical imaging system may be miniaturized.

In an embodiment, an optical imaging system may satisfy 0.4<|fG1/fG2|<1 (Conditional Expression 7). In this case, fG2 is a focal length of a second lens group. Therefore, the optical imaging system may be miniaturized, and a resolution may be improved by appropriately distributing the refractive powers of the lens groups.

In an embodiment, an optical imaging system may satisfy-1.4<f/fG2<−0.6 (Conditional Expression 8). Therefore, a focal length of a second lens group may be optimized to improve a resolution.

In an embodiment, an optical imaging system may satisfy 0.2<RG1_S1/fG1<0.6 (Conditional Expression 9). In this case, RG1_S1 is a radius of curvature of an object-side surface of a first lens of a first lens group. Therefore, an occurrence of aberrations may be minimized.

In an embodiment, an optical imaging system may satisfy 0.3<Lf/Lr<0.6 (Conditional Expression 10). In this case, Lf is a distance along the optical axis of the optical imaging system from an object-side surface of a first lens of a first lens group to a reflective surface of a reflective member. Therefore, the optical imaging system may be miniaturized.

In an embodiment, an optical imaging system may satisfy 0<DG2/TTL<0.2 (Conditional Expression 11). In this case, DG2 is a distance along the optical axis of the optical imaging system from an object-side surface of a first lens of a second lens group (e.g., a third lens or a fourth lens) to an image-side surface of a last lens of a second lens group (e.g., a fifth lens or a sixth lens). Therefore, the optical imaging system may be miniaturized.

In an embodiment, an optical imaging system may satisfy 0.5<fG1/TTL<0.9 (Conditional Expression 12). Therefore, a focal length of a first lens group may be optimized to miniaturize the optical imaging system.

In an embodiment, an optical imaging system may satisfy 2.8<f/CA_G11<3.2 (Conditional Expression 13). Therefore, a brightness and a resolution of an image may be improved.

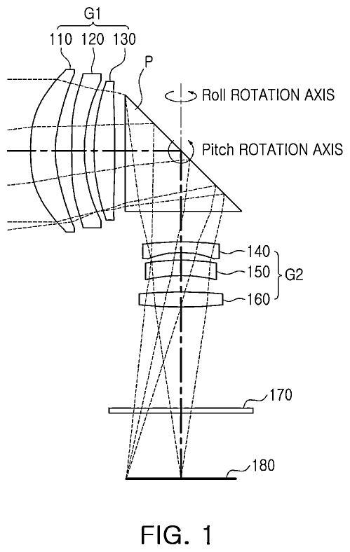

FIG. 1 is a configuration diagram of an optical imaging system according to a first embodiment of the present disclosure.

Referring to FIG. 1, an optical imaging system according to the first embodiment of the present disclosure may include a first lens group G1 and a second lens group G2. In addition, the optical imaging system may include a reflective member P disposed between the first lens group G1 and the second lens group G2.

In sequential order from an object side of the optical imaging system, the first lens group G1 may include a first lens 110, a second lens 120, and a third lens 130, and the second lens group G2 may include a fourth lens 140, a fifth lens 150, and a sixth lens 160.

In addition, the optical imaging system may further include a filter 170 and an image sensor (not shown).

The optical imaging system according to the first embodiment of the present disclosure may focus an image on an image plane 180. The image plane 180 may be a surface on which the image is focused by the optical imaging system. For example, the image plane 180 may be a surface of the image sensor on which light is incident.

In the first embodiment of the present disclosure, the reflective member P may be a prism, but may alternatively be a mirror.

Characteristics of each of the first lens 110 to the sixth 160 (a radius of curvature, a thickness of the lens or a distance between lenses, a refractive index, an Abbe number, an effective radius, and a focal length) may be as illustrated in Table 1 below.

TABLE 1

| Surface | | Radius of | Thickness or | Refractive | Abbe | Effective | Focal |
|---|---|---|---|---|---|---|---|
| No. | Element | Curvature | Distance | Index | No. | Radius | Length |
| S1 | First | 3.834 | 1.040 | 1.535 | 55.7 | 3.200 | 22.601 |
| S2 | Lens | 5.072 | 0.631 | | | 3.120 | |
| S3 | Second | 22.381 | 0.479 | 1.639 | 23.5 | 3.010 | −24.441 |
| S4 | Lens | 9.176 | 0.411 | | | 2.750 | |
| S5 | Third | 6.278 | 0.800 | 1.535 | 55.7 | 2.728 | 10.837 |
| S6 | Lens | −76.385 | 0.400 | | | 2.663 | |
| S7 | Prism | Infinity | 2.200 | 1.883 | 40.8 | 2.539 | |
| S8 | | Infinity | 2.400 | | | 2.211 | |
| S9 | | Infinity | 1.200 | | | 1.854 | |
| S10 | Fourth | 21.746 | 0.400 | 1.614 | 25.9 | 1.483 | −8.408 |
| S11 | Lens | 4.175 | 0.341 | | | 1.346 | |
| S12 | Fifth | 8.649 | 0.585 | 1.544 | 56.0 | 1.322 | −30.769 |
| S13 | Lens | 5.574 | 0.627 | | | 1.400 | |
| S14 | Sixth | 9.750 | 0.588 | 1.639 | 23.5 | 1.551 | 13.035 |
| S15 | Lens | −60.010 | 4.001 | | | 1.650 | |
| S16 | Filter | Infinity | 0.210 | 1.517 | 64.2 | 2.806 | |
| S17 | | Infinity | 2.564 | | | 2.845 | |
| S18 | Image | Infinity | | | | | |
| | Plane | | | | | | |

In the optical imaging system according to the first embodiment of the present disclosure, the first lens group G1 may have a positive refractive power as a whole, and the second lens group G2 may have a negative refractive power as a whole.

The first lens 110 may have a positive refractive power, a convex object-side surface in a paraxial region thereof, and a concave image-side surface in a paraxial region thereof.

The second lens 120 may have a negative refractive power, a convex object-side surface in a paraxial region thereof, and an concave image-side surface in a paraxial region thereof.

The third lens 130 may have a positive refractive power, a convex object-side surface in a paraxial region thereof, and a convex image-side surface in a paraxial region thereof.

The fourth lens 140 may have a negative refractive power, a convex object-side surface in a paraxial region thereof, and a concave image-side surface in a paraxial region thereof.

The fifth lens 150 may have a negative refractive power, a convex object-side surface in a paraxial region thereof, and a concave image-side surface in a paraxial region thereof.

The sixth lens 160 may have a positive refractive power, a convex object-side surface in a paraxial region thereof, and a convex image-side surface in a paraxial region thereof.

Each of the surfaces of the first lens 110 to the sixth lens 160 may have aspherical coefficients as illustrated in Table 2 below. For example, the object-side surface and the image-side surface of each of the first lens 110 to the sixth lens 160 may be aspherical.

TABLE 2

| | S1 | S2 | S3 | S4 | S5 | S6 |
|---|---|---|---|---|---|---|
| Conic | 3.824E−02 | −3.706E+00 | 1.397E+01 | 1.211E+00 | −1.356E+01 | −2.000E+01 |
| Constant (K) | | | | | | |
| 4th Coef- | −2.420E−03 | −2.759E−03 | −3.647E−04 | −2.335E−03 | −3.142E−03 | −2.869E−03 |
| ficient (A) | | | | | | |
| 6th Coef- | 7.192E−04 | 2.745E−03 | 1.917E−03 | 4.694E−03 | 3.964E−03 | 8.797E−04 |
| ficient (B) | | | | | | |
| 8th Coef- | −2.207E−04 | −1.385E−03 | 7.201E−04 | −4.847E−04 | −1.875E−03 | −1.383E−04 |
| ficient (C) | | | | | | |
| 10th Coef- | 3.741E−06 | 5.567E−04 | −1.010E−03 | −7.681E−04 | 4.756E−04 | −7.028E−06 |
| ficient (D) | | | | | | |
| 12th Coef- | 2.134E−05 | −1.715E−04 | 4.203E−04 | 3.895E−04 | −6.635E−05 | 4.646E−06 |
| ficient (E) | | | | | | |
| 14th Coef- | −7.999E−06 | 3.615E−05 | −9.322E−05 | −7.647E−05 | 4.764E−06 | −1.209E−07 |
| ficient (F) | | | | | | |
| 16th Coef- | 1.433E−06 | −4.911E−06 | 1.221E−05 | 5.403E−06 | −1.340E−07 | −2.430E−08 |
| ficient (G) | | | | | | |
| 18th Coef- | −1.416E−07 | 4.087E−07 | −9.511E−07 | 2.845E−07 | 0.000E+00 | 0.000E+00 |
| ficient (H) | | | | | | |
| 20th Coef- | 7.446E−09 | −1.894E−08 | 4.101E−08 | −6.380E−08 | 0.000E+00 | 0.000E+00 |
| ficient (J) | | | | | | |
| 22nd Coef- | −1.638E−10 | 3.736E−10 | −7.576E−10 | 2.694E−09 | 0.000E+00 | 0.000E+00 |
| ficient (L) | | | | | | |

| | S10 | S11 | S12 | S13 | S14 | S15 |
|---|---|---|---|---|---|---|
| Conic | −2.000E+01 | 6.451E+00 | 1.111E+01 | 1.158E+01 | −1.310E+01 | 8.955E+00 |
| Constant (K) | | | | | | |
| 4th Coef- | 1.459E−02 | 1.518E−02 | 2.166E−02 | −4.185E−03 | −2.525E−02 | −2.048E−02 |
| ficient (A) | | | | | | |
| 6th Coef- | −4.036E−02 | −6.636E−02 | −5.056E−02 | −4.527E−03 | 7.344E−02 | 3.983E−02 |
| ficient (B) | | | | | | |
| 8th Coef- | 5.808E−02 | 6.549E−02 | 3.174E−02 | −2.949E−02 | −1.628E−01 | −7.207E−02 |
| ficient (C) | | | | | | |
| 10th Coef- | −4.156E−02 | −2.434E−02 | −4.319E−04 | 4.843E−02 | 2.220E−01 | 8.059E−02 |
| ficient (D) | | | | | | |
| 12th Coef- | 1.679E−02 | −1.785E−03 | −6.666E−03 | −3.400E−02 | −1.951E−01 | −5.803E−02 |
| ficient (E) | | | | | | |
| 14th Coef- | −3.691E−03 | 3.175E−03 | 1.551E−03 | 1.098E−02 | 1.135E−01 | 2.755E−02 |
| ficient (F) | | | | | | |
| 16th Coef- | 3.449E−04 | −6.161E−04 | 7.456E−05 | −1.382E−03 | −4.336E−02 | −8.507E−03 |
| ficient (G) | | | | | | |
| 18th Coef- | 0.000E+00 | 0.000E+00 | 0.000E+00 | 0.000E+00 | 1.039E−02 | 1.611E−03 |
| ficient (H) | | | | | | |
| 20th Coef- | 0.000E+00 | 0.000E+00 | 0.000E+00 | 0.000E+00 | −1.408E−03 | −1.647E−04 |
| ficient (J) | | | | | | |
| 22nd Coef- | 0.000E+00 | 0.000E+00 | 0.000E+00 | 0.000E+00 | 8.179E−05 | 6.595E−06 |
| ficient (L) | | | | | | |

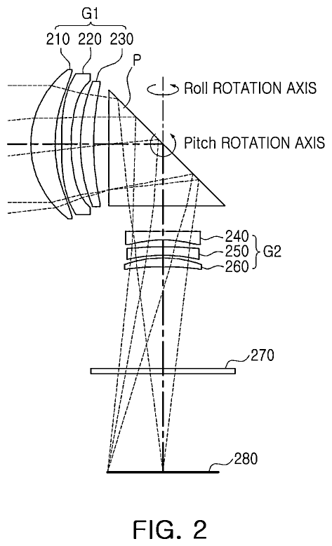

FIG. 2 is a configuration diagram of an optical imaging system according to a second embodiment of the present disclosure.

Referring to FIG. 2, the optical imaging system according to the second embodiment of the present disclosure may include a first lens group G1 and a second lens group G2. In addition, the optical imaging system may include a reflective member P disposed between the first lens group G1 and the second lens group G2.

In sequential order from an object side of the optical imaging system, the first lens group G1 may include a first lens 210, a second lens 220, and a third lens 230, and the second lens group G2 may include a fourth lens 240, a fifth lens 250, and a sixth lens 260.

In addition, the optical imaging system may further include a filter 270 and an image sensor (not shown).

The optical imaging system according to the second embodiment of the present disclosure may focus an image on an image plane 280. The image plane 280 may be a surface on which the image is focused by the optical imaging system. For example, the image plane 280 may be a surface of the image sensor on which light is incident.

In the second embodiment of the present disclosure, the reflective member P may be a prism, but may alternatively be a mirror.

Characteristics of each of the first lens 210 to the sixth lens 260 (a radius of curvature, a thickness of the lens or a distance between lenses, a refractive index, an Abbe number, an effective radius, and a focal length) may be as illustrated in Table 3 below.

TABLE 3

| Surface | | Radius of | Thickness or | Refractive | Abbe | Effective | Focal |
|---|---|---|---|---|---|---|---|
| No. | Element | Curvature | Distance | Index | No. | Radius | Length |
| S1 | First | 3.540 | 0.970 | 1.537 | 55.7 | 2.925 | 19.544 |
| S2 | Lens | 4.833 | 0.271 | | | 2.866 | |
| S3 | Second | 17.281 | 0.381 | 1.644 | 23.5 | 2.798 | −20.737 |
| S4 | Lens | 7.468 | 0.329 | | | 2.498 | |
| S5 | Third | 4.300 | 0.558 | 1.546 | 56.0 | 2.476 | 12.017 |
| S6 | Lens | 11.918 | 0.642 | | | 2.407 | |
| S7 | Prism | Infinity | 2.050 | 1.790 | 25.7 | 2.309 | |
| S8 | | Infinity | 2.450 | 1.790 | 25.7 | 2.032 | |
| S9 | | Infinity | 1.000 | | | 1.702 | |
| S10 | Fourth | 21.769 | 0.350 | 1.619 | 25.9 | 1.450 | −8.300 |
| S11 | Lens | 4.130 | 0.252 | | | 1.417 | |
| S12 | Fifth | 10.238 | 0.350 | 1.619 | 25.9 | 1.457 | −15.331 |
| S13 | Lens | 4.859 | 0.111 | | | 1.462 | |
| S14 | Sixth | 3.821 | 0.350 | 1.667 | 20.4 | 1.500 | 7.819 |
| S15 | Lens | 13.801 | 4.001 | | | 1.511 | |
| S16 | Filter | Infinity | 0.210 | 1.518 | 64.2 | 2.417 | |
| S17 | | Infinity | 3.903 | | | 2.454 | |
| S18 | Image | Infinity | | | | | |
| | Plane | | | | | | |

In the optical imaging system according to the second embodiment of the present disclosure, the first lens group G1 may have a positive refractive power as a whole, and the second lens group G2 may have a negative refractive power as a whole.

The first lens 210 may have a positive refractive power, a convex object-side surface in a paraxial region thereof, and a concave image-side surface in a paraxial region thereof.

The second lens 220 may have a negative refractive power, a convex object-side surface in a paraxial region thereof, and a concave image-side surface in a paraxial region thereof.

The third lens 230 may have a positive refractive power, a convex object-side surface in a paraxial region thereof, and a concave image-side surface in a paraxial region thereof.

The fourth lens 240 may have a negative refractive power, a convex object-side surface in a paraxial region thereof, and a concave image-side surface in a paraxial region thereof.

The fifth lens 250 may have a negative refractive power, a convex object-side surface in a paraxial region thereof, and a concave image-side surface in a paraxial region thereof.

The sixth lens 260 may have a positive refractive power, a convex object-side surface in a paraxial region thereof, and a concave image-side surface in a paraxial region thereof.

Each of the surfaces of the first lens 210 to the sixth lens 260 may have aspherical coefficients as illustrated in Table 4 below. For example, the object-side surface and the image-side surface of each of the first lens 210 to the sixth lens 260 may be aspherical.

TABLE 4

| | S1 | S2 | S3 | S4 | S5 | S6 |
|---|---|---|---|---|---|---|
| Conic | 5.107E−02 | −3.333E+00 | 1.113E+01 | 2.469E+00 | −5.437E+00 | 0.000E+00 |
| Constant (K) | | | | | | |
| 4th Coef- | −3.307E−03 | −3.172E−03 | 3.024E−03 | −3.110E−03 | −4.185E−03 | 0.000E+00 |
| ficient (A) | | | | | | |
| 6th Coef- | 1.963E−03 | 2.894E−03 | 2.056E−03 | 6.654E−03 | 3.836E−03 | 0.000E+00 |
| ficient (B) | | | | | | |
| 8th Coef- | −7.994E−04 | −1.130E−03 | −1.182E−03 | −3.523E−03 | −1.864E−03 | 0.000E+00 |
| ficient (C) | | | | | | |
| 10th Coef- | 1.996E−04 | 2.490E−04 | 3.432E−04 | 1.085E−03 | 4.760E−04 | 0.000E+00 |
| ficient (D) | | | | | | |
| 12th Coef- | −2.900E−05 | −3.200E−05 | −5.000E−05 | −1.751E−04 | −6.700E−05 | 0.000E+00 |
| ficient (E) | | | | | | |
| 14th Coef- | 2.000E−06 | 2.000E−06 | 4.000E−06 | 1.400E−05 | 5.000E−06 | 0.000E+00 |
| ficient (F) | | | | | | |
| 16th Coef- | −7.570E−08 | −6.249E−08 | −9.916E−08 | −4.020E−07 | −1.367E−07 | 0.000E+00 |
| ficient (G) | | | | | | |
| 18th Coef- | −4.902E−12 | 3.254E−12 | 1.293E−11 | −2.841E−10 | 4.552E−11 | 0.000E+00 |
| ficient (H) | | | | | | |
| | S10 | S11 | S12 | S13 | S14 | S15 |
| Conic | −5.778E+01 | 6.542E+00 | 2.307E+01 | 8.840E+00 | −4.984E+00 | 4.210E+01 |
| Constant (K) | | | | | | |
| 4th Coef- | 0.001 | −0.005 | 0.025 | −0.006 | −0.002 | −0.005 |
| ficient (A) | | | | | | |
| 6th Coef- | −4.059E−02 | −6.704E−02 | −5.044E−02 | −7.832E−03 | 8.126E−03 | 1.506E−02 |
| ficient (B) | | | | | | |
| 8th Coef- | 5.946E−02 | 6.496E−02 | 3.036E−02 | −2.761E−02 | −1.087E−02 | −1.970E−02 |
| ficient (C) | | | | | | |
| 10th Coef- | −4.221E−02 | −2.394E−02 | 5.034E−04 | 4.842E−02 | 6.436E−03 | 1.398E−02 |
| ficient (D) | | | | | | |
| 12th Coef- | 1.687E−02 | −1.752E−03 | −6.551E−03 | −3.414E−02 | −1.867E−04 | −4.719E−03 |
| ficient (E) | | | | | | |
| 14th Coef- | −3.671E−03 | 3.175E−03 | 1.551E−03 | 1.098E−02 | −1.128E−03 | 5.273E−04 |
| ficient (F) | | | | | | |
| 16th Coef- | 3.449E−04 | −6.161E−04 | 7.500E−05 | −1.382E−03 | 2.674E−04 | 1.600E−05 |
| ficient (G) | | | | | | |
| 18th Coef- | −8.266E−18 | −8.206E−18 | −8.269E−18 | −8.278E−18 | −8.263E−18 | −8.262E−18 |
| ficient (H) | | | | | | |

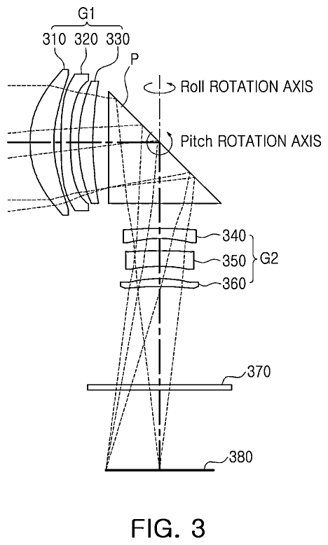

FIG. 3 is a configuration diagram of an optical imaging system according to a third embodiment of the present disclosure.

Referring to FIG. 3, the optical imaging system according to the third embodiment of the present disclosure may include a first lens group G1 and a second lens group G2. In addition, the optical imaging system may include a reflective member P disposed between the first lens group G1 and the second lens group G2.

In sequential order from an object side of the optical imaging system, the first lens group G1 may include a first lens 310, a second lens 320, and a third lens 330, and the second lens group G2 may include a fourth lens 340, a fifth lens 350, and a sixth lens 360.

In addition, the optical imaging system may further include a filter 370 and an image sensor (not shown).

The optical imaging system according to the third embodiment of the present disclosure may focus an image on an image plane 380. The image plane 380 may be a surface on which the image is focused by the optical imaging system. For example, the image plane 380 may be a surface of the image sensor on which light is incident.

In the third embodiment of the present disclosure, the reflective member P may be a prism, but may alternatively be a mirror.

Characteristics of each of the first lens 310 to the sixth lens 360 (a radius of curvature, a thickness of the lens or a distance between lenses, a refractive index, an Abbe number, an effective radius, and a focal length) may be as illustrated in Table 5 below.

TABLE 5

| Surface | | Radius of | Thickness or | Refractive | Abbe | Effective | Focal |
|---|---|---|---|---|---|---|---|
| No. | Element | Curvature | Distance | Index | No. | Radius | Length |
| S1 | First | 3.693 | 0.990 | 1.537 | 55.7 | 2.986 | 19.154 |
| S2 | Lens | 5.224 | 0.277 | | | 2.930 | |
| S3 | Second | 17.886 | 0.388 | 1.644 | 23.5 | 2.823 | −26.246 |
| S4 | Lens | 8.617 | 0.336 | | | 2.555 | |
| S5 | Third | 4.814 | 0.570 | 1.546 | 56.0 | 2.541 | 13.892 |
| S6 | Lens | 12.635 | 0.656 | | | 2.480 | |
| S7 | Prism | Infinity | 2.100 | 1.790 | 25.7 | 2.362 | |
| S8 | | Infinity | 2.500 | 1.790 | 25.7 | 2.071 | |
| S9 | | Infinity | 1.021 | | | 1.725 | |
| S10 | Fourth | 22.284 | 0.405 | 1.619 | 25.9 | 1.457 | −9.224 |
| S11 | Lens | 4.512 | 0.504 | | | 1.351 | |
| S12 | Fifth | 11.683 | 0.625 | 1.619 | 25.9 | 1.286 | −16.172 |
| S13 | Lens | 5.279 | 0.491 | | | 1.346 | |
| S14 | Sixth | 3.142 | 0.350 | 1.667 | 20.4 | 1.531 | 9.138 |
| S15 | Lens | 6.199 | 4.001 | | | 1.587 | |
| S16 | Filter | Infinity | 0.210 | 1.518 | 64.2 | 2.629 | |
| S17 | | Infinity | 3.273 | | | 2.666 | |
| S18 | Image | Infinity | | | | | |
| | Plane | | | | | | |

In the optical imaging system according to the third embodiment of the present disclosure, the first lens group G1 may have a positive refractive power as a whole, and the second lens group G2 may have a negative refractive power as a whole.

The first lens 310 may have a positive refractive power, a convex object-side surface in a paraxial region thereof, and a concave image-side surface in a paraxial region thereof.

The second lens 320 may have a negative refractive power, a convex object-side surface in a paraxial region thereof, and a concave image-side surface in a paraxial region thereof.

The third lens 330 may have a positive refractive power, a convex object-side surface in a paraxial region thereof, and a concave image-side surface in a paraxial region thereof.

The fourth lens 340 may have a negative refractive power, a convex object-side surface in a paraxial region thereof, and a concave image-side surface in a paraxial region thereof.

The fifth lens 350 may have a negative refractive power, a convex object-side surface in a paraxial region thereof, and a concave image-side surface in a paraxial region thereof.

The sixth lens 360 may have a positive refractive power, a convex object-side surface in a paraxial region thereof, and a concave image-side surface in a paraxial region thereof.

Each of the surfaces of the first lens 310 to the sixth lens 360 may have aspherical coefficients as illustrated in Table 6 below. For example, the object-side surface and the image-side surface of each of the first lens 310 to the sixth lens 360 may be aspherical.

TABLE 6

| | S1 | S2 | S3 | S4 | S5 | S6 |
|---|---|---|---|---|---|---|
| Conic | 3.226E−02 | −3.360E+00 | 9.489E+00 | 3.394E+00 | −5.824E+00 | 0.000E+00 |
| Constant (K) | | | | | | |
| 4th Coef- | −3.468E−03 | −3.268E−03 | 2.926E−03 | −2.595E−03 | −3.691E−03 | 0.000E+00 |
| ficient (A) | | | | | | |
| 6th Coef- | 1.812E−03 | 2.586E−03 | 1.869E−03 | 6.071E−03 | 3.492E−03 | 0.000E+00 |
| ficient (B) | | | | | | |
| 8th Coef- | −6.983E−04 | −9.787E−04 | −1.016E−03 | −3.047E−03 | −1.607E−03 | 0.000E+00 |
| ficient (C) | | | | | | |
| 10th Coef- | 1.650E−04 | 2.064E−04 | 2.859E−04 | 8.979E−04 | 3.946E−04 | 0.000E+00 |
| ficient (D) | | | | | | |
| 12th Coef- | −2.300E−05 | −2.600E−05 | −4.000E−05 | −1.392E−04 | −5.300E−05 | 0.000E+00 |
| ficient (E) | | | | | | |
| 14th Coef- | 2.000E−06 | 2.000E−06 | 3.000E−06 | 1.100E−05 | 4.000E−06 | 0.000E+00 |
| ficient (F) | | | | | | |
| 16th Coef- | −5.566E−08 | −4.594E−08 | −7.299E−08 | −2.904E−07 | −9.364E−08 | 0.000E+00 |
| ficient (G) | | | | | | |
| 18th Coef- | −5.282E−12 | −2.847E−12 | −4.741E−12 | −3.087E−10 | 4.180E−12 | 0.000E+00 |
| ficient (H) | | | | | | |
| | S10 | S11 | S12 | S13 | S14 | S15 |
| Conic | −7.189E+01 | 7.103E+00 | 1.045E+01 | 9.527E+00 | −1.103E+01 | −3.052E+01 |
| Constant (K) | | | | | | |
| 4th Coef- | 0.000 | −0.004 | 0.024 | −0.016 | −0.013 | −0.025 |
| ficient (A) | | | | | | |
| 6th Coef- | −3.491E−02 | −5.915E−02 | −5.235E−02 | −6.191E−03 | 3.245E−03 | 1.362E−02 |
| ficient (B) | | | | | | |
| 8th Coef- | 5.154E−02 | 5.578E−02 | 2.513E−02 | −2.478E−02 | −9.278E−03 | −1.707E−02 |
| ficient (C) | | | | | | |
| 10th Coef- | −3.491E−02 | −2.041E−02 | 6.625E−04 | 3.988E−02 | 5.593E−03 | 1.146E−02 |
| ficient (D) | | | | | | |
| 12th Coef- | 1.340E−02 | −1.043E−03 | −5.311E−03 | −2.698E−02 | −1.553E−04 | −3.760E−03 |
| ficient (E) | | | | | | |
| 14th Coef- | −2.804E−03 | 2.425E−03 | 1.184E−03 | 8.386E−03 | −9.016E−04 | 4.075E−04 |
| ficient (F) | | | | | | |
| 16th Coef- | 2.527E−04 | −4.514E−04 | 5.500E−05 | −1.012E−03 | 1.959E−04 | 1.100E−05 |
| ficient (G) | | | | | | |
| 18th Coef- | −7.452E−17 | −7.937E−17 | −7.941E−17 | −8.537E−17 | −7.819E−17 | −8.311E+00 |
| ficient (H) | | | | | | |

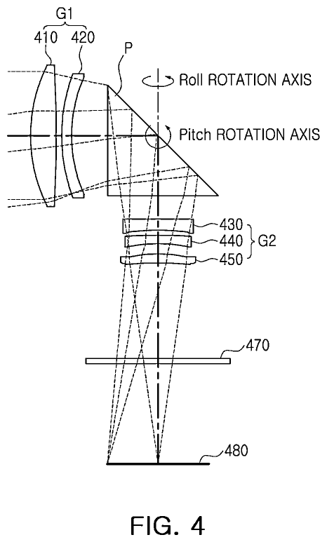

FIG. 4 is a configuration diagram of an optical imaging system according to a fourth embodiment of the present disclosure.

Referring to FIG. 4, the optical imaging system according to the fourth embodiment of the present disclosure may include a first lens group G1 and a second lens group G2. In addition, the optical imaging system may include a reflective member P disposed between the first lens group G1 and the second lens group G2.

In sequential order from an object side of the optical imaging system, the first lens group G1 may include a first lens 410 and a second lens 420, and the second lens G2 group may include a third lens 430, a fourth lens 440, and a fifth lens 450.

In addition, the optical imaging system may further include a filter 470 and an image sensor (not shown).

The optical imaging system according to the fourth embodiment of the present disclosure may focus an image on an image plane 480. The image plane 480 may be a surface on which the image is focused by the optical imaging system. For example, the image plane 480 may be a surface of the image sensor on which light is incident.

In the fourth embodiment of the present disclosure, the reflective member P may be a prism, but may alternatively be a mirror.

Characteristics of each of the first lens 410 to the fifth lens 450 (a radius of curvature, a thickness of the lens or a distance between lenses, a refractive index, an Abbe number, an effective radius, and a focal length) may be as illustrated in Table 7 below.

TABLE 7

| Surface | | Radius of | Thickness or | Refractive | Abbe | Effective | Focal |
|---|---|---|---|---|---|---|---|
| No. | Element | Curvature | Distance | Index | No. | Radius | Length |
| S1 | First | 6.470 | 1.060 | 1.534 | 55.7 | 2.985 | 11.460 |
| S2 | Lens | −116.918 | 0.277 | | | 2.933 | |
| S3 | Second | 7.244 | 0.388 | 1.636 | 23.5 | 2.700 | −57.964 |
| S4 | Lens | 5.940 | 1.561 | | | 2.552 | |
| S5 | Prism | Infinity | 2.100 | 1.782 | 25.7 | 2.330 | |
| S6 | | Infinity | 2.500 | 1.782 | 25.7 | 2.071 | |
| S7 | | Infinity | 1.021 | | | 1.762 | |
| S8 | Third | 19.306 | 0.463 | 1.612 | 25.9 | 1.532 | −10.763 |
| S9 | Lens | 4.906 | 0.216 | | | 1.494 | |
| S10 | Fourth | 13.991 | 0.350 | 1.612 | 25.9 | 1.485 | −13.615 |
| S11 | Lens | 5.208 | 0.426 | | | 1.483 | |
| S12 | Fifth | 3.781 | 0.395 | 1.657 | 20.4 | 1.531 | 8.130 |
| S13 | Lens | 11.990 | 4.001 | | | 1.589 | |
| S14 | Filter | Infinity | 0.210 | 1.516 | 64.2 | 2.534 | |
| S15 | | Infinity | 4.224 | | | 2.566 | |
| S16 | Image | Infinity | | | | | |
| | Plane | | | | | | |

In the optical imaging system according to the fourth embodiment of the present disclosure, the first lens group G1 may have a positive refractive power as a whole, and the second lens group G2 may have a negative refractive power as a whole.

The first lens 410 may have a positive refractive power, a convex object-side surface in a paraxial region thereof, and a convex image-side surface in a paraxial region thereof.

The second lens 420 may have a negative refractive power, a convex object-side surface in a paraxial region thereof, and a concave image-side surface of the second lens 420 may have a concave shape.

The third lens 430 may have a negative refractive power, a convex object-side surface in a paraxial region thereof, and a concave image-side surface in a paraxial region thereof.

The fourth lens 440 may have a negative refractive power, a convex object-side surface in a paraxial region thereof, and a concave image-side surface in a paraxial region thereof.

The fifth lens 450 may have a positive refractive power, a convex object-side surface in a paraxial region thereof, and a concave image-side surface in a paraxial region thereof.

Each of the surfaces of the first lens 410 to the fifth lens 450 may have aspherical coefficients as illustrated in Table 8 below. For example, the object-side surface and the image-side surface of each of the first lens 410 to the fifth lens 450 may be aspherical.

TABLE 8

| | S1 | S2 | S3 | S4 | S8 |
|---|---|---|---|---|---|
| Conic Constant (K) | 0.000E+00 | 0.000E+00 | 0.000E+00 | 0.000E+00 | 0.000E+00 |
| 4th Coefficient (A) | −1.271E−04 | −1.579E−05 | −6.031E−06 | 4.931E−04 | −7.944E−03 |
| 6th Coefficient (B) | −1.523E−05 | −8.314E−06 | 1.187E−05 | −1.913E−04 | −3.431E−02 |
| 8th Coefficient (C) | 6.136E−07 | −1.101E−06 | −1.048E−05 | 4.646E−05 | 4.983E−02 |
| 10th Coefficient (D) | 4.811E−08 | 4.829E−09 | −1.875E−07 | −5.169E−06 | −3.449E−02 |
| 12th Coefficient (E) | −2.279E−09 | 8.500E−09 | −1.069E−07 | −6.253E−07 | 1.344E−02 |
| 14th Coefficient (F) | −4.882E−10 | 8.635E−10 | 2.701E−08 | 1.113E−07 | −2.819E−03 |
| 16th Coefficient (G) | −2.188E−11 | 4.296E−11 | 0.000E+00 | 0.000E+00 | 2.527E−04 |
| 18th Coefficient (H) | 2.901E−12 | 1.324E−13 | 0.000E+00 | 0.000E+00 | −8.540E−16 |
| 20th Coefficient (J) | 7.698E−13 | −9.317E−14 | 0.000E+00 | 0.000E+00 | −7.547E−17 |

| | S9 | S10 | S11 | S12 | S13 |
|---|---|---|---|---|---|
| Conic Constant (K) | 8.564 | 53.404 | 9.409 | −12.113 | 18.466 |
| 4th Coefficient (A) | −8.148E−03 | 3.288E−02 | −1.033E−02 | −9.290E−03 | −2.122E−02 |
| 6th Coefficient (B) | −6.513E−02 | −5.369E−02 | −2.769E−03 | 2.788E−03 | 1.206E−02 |
| 8th Coefficient (C) | 5.599E−02 | 2.476E−02 | −2.493E−02 | −9.284E−03 | −1.752E−02 |
| 10th Coefficient (D) | −2.035E−02 | 9.733E−04 | 3.961E−02 | 5.453E−03 | 1.164E−02 |
| 12th Coefficient (E) | −1.047E−03 | −5.380E−03 | −2.693E−02 | −7.969E−05 | −3.739E−03 |
| 14th Coefficient (F) | 2.436E−03 | 1.182E−03 | 8.385E−03 | −8.983E−04 | 4.114E−04 |
| 16th Coefficient (G) | −4.514E−04 | 5.463E−05 | −1.012E−03 | 1.982E−04 | 1.069E−05 |
| 18th Coefficient (H) | −9.265E−16 | −9.199E−16 | −1.009E−15 | −1.364E−15 | −1.409E−15 |
| 20th Coefficient (J) | −8.032E−17 | −8.035E−17 | −8.631E−17 | −7.914E−17 | −8.405E−17 |

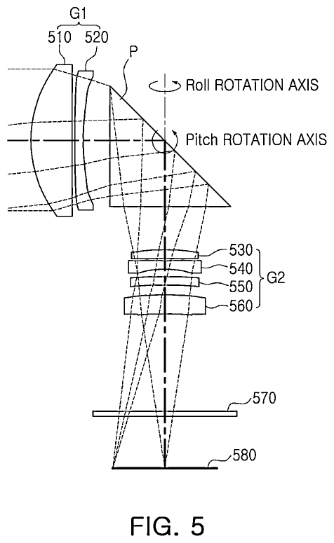

FIG. 5 is a configuration diagram of an optical imaging system according to a fifth embodiment of the present disclosure.

Referring to FIG. 5, the optical imaging system according to the fifth embodiment of the present disclosure may include a first lens group G1 and a second lens group G2. In addition, the optical imaging system may include a reflective member P disposed between the first lens group G1 and the second lens group G2.

In sequential order from an object side of the optical imaging system, the first lens group G1 may include a first lens 510 and a second lens 520, and the second lens group G2 may include a third lens 530, a fourth lens 540, a fifth lens 550, and a sixth lens 560.

In addition, the optical imaging system may further include a filter 570 and an image sensor (not shown).

The optical imaging system according to the fifth embodiment of the present disclosure may focus an image on an image plane 580. The image plane 580 may be a surface on which the image is focused by the optical imaging system. For example, the image plane 580 may be a surface of the image sensor on which light is incident.

In the fifth embodiment of the present disclosure, the reflective member P may be a prism, but may alternatively be a mirror.

Characteristics of each of the first lens 510 to the sixth lens 560 (a radius of curvature, a thickness of the lens or a distance between lenses, a refractive index, an Abbe number, an effective radius, and a focal length) may be as illustrated in Table 9 below.

TABLE 9

| Surface | | Radius of | Thickness or | Refractive | Abbe | Effective | Focal |
|---|---|---|---|---|---|---|---|
| No. | Element | Curvature | Distance | Index | No. | Radius | Length |
| S1 | First | 5.311 | 1.736 | 1.534 | 55.7 | 3.100 | 9.539 |
| S2 | Lens | −125.278 | 0.100 | | | 2.928 | |
| S3 | Second | 308.377 | 0.350 | 1.612 | 25.9 | 2.829 | −28.333 |
| S4 | Lens | 16.580 | 1.013 | | | 2.611 | |
| S5 | Prism | Infinity | 2.300 | 1.782 | 25.7 | 2.462 | |
| S6 | | Infinity | 2.700 | 1.782 | 25.7 | 2.214 | |
| S7 | | Infinity | 2.000 | | | 1.933 | |
| S8 | Third | 6.679 | 0.350 | 1.543 | 56.0 | 1.531 | 25.821 |
| S9 | Lens | 12.463 | 0.100 | | | 1.493 | |
| S10 | Fourth | −32.161 | 0.350 | 1.612 | 25.9 | 1.480 | −6.091 |
| S11 | Lens | 4.286 | 0.299 | | | 1.372 | |
| S12 | Fifth | 31.612 | 0.350 | 1.566 | 37.4 | 1.378 | −55.450 |
| S13 | Lens | 15.740 | 0.392 | | | 1.427 | |
| S14 | Sixth | 7.010 | 0.800 | 1.667 | 19.2 | 1.531 | 12.119 |
| S15 | Lens | 45.961 | 4.001 | | | 1.678 | |
| S16 | Filter | Infinity | 0.210 | 1.516 | 64.2 | 2.983 | |
| S17 | | Infinity | 1.690 | | | 3.027 | |
| S18 | Image | Infinity | | | | | |
| | Plane | | | | | | |

In the optical imaging system according to the fifth embodiment of the present disclosure, the first lens group G1 may have a positive refractive power as a whole, and the second lens group G2 may have a negative refractive power as a whole.

The first lens 510 may have a positive refractive power, a convex object-side surface in a paraxial region thereof, and a convex image-side surface in a paraxial region thereof.

The second lens 520 may have a negative refractive power, a convex object-side surface a paraxial region thereof, and a concave mage-side surface in a paraxial region thereof.

The third lens 530 may have a positive refractive power, a convex object-side surface a paraxial region thereof, and a concave image-side surface in a paraxial region thereof.

The fourth lens 540 may have a negative refractive power, a concave object-side surface a paraxial region thereof, and a concave image-side surface in a paraxial region thereof.

The fifth lens 550 may have a negative refractive power, a convex object-side surface a paraxial region thereof, and a concave image-side surface in a paraxial region thereof.

The sixth lens 560 may have a positive refractive power, a convex object-side surface a paraxial region thereof, and a concave image-side surface in a paraxial region thereof.

Each of the surfaces of the first lens 510 to the sixth lens 560 may have aspherical coefficients as illustrated in Table 10 below. For example, the object-side surface and the image-side surface of each of the first lens 510 to the sixth lens 560 may be aspherical.

TABLE 10

| | S1 | S2 | S3 | S4 | S8 | S9 |
|---|---|---|---|---|---|---|
| Conic | 0.000E+00 | 0.000E+00 | 0.000E+00 | 0.000E+00 | 0.000E+00 | 0.000E+00 |
| Constant (K) | | | | | | |
| 4th Coef- | 6.229E−04 | 4.751E−04 | 7.502E−04 | 2.031E−03 | −3.608E−03 | −3.578E−03 |
| ficient (A) | | | | | | |
| 6th Coef- | 3.206E−05 | 9.871E−06 | 5.686E−05 | 6.392E−05 | 9.049E−04 | −2.179E−03 |
| ficient (B) | | | | | | |
| 8th Coef- | 1.516E−06 | −1.050E−06 | 9.278E−06 | 3.399E−05 | −1.352E−03 | −2.992E−05 |
| ficient (C) | | | | | | |
| 10th Coef- | −5.864E−09 | −8.841E−08 | 7.212E−07 | −2.072E−07 | 9.445E−05 | 1.678E−05 |
| ficient (D) | | | | | | |
| 12th Coef- | −7.361E−09 | −3.331E−09 | −1.471E−07 | −1.635E−07 | 9.684E−16 | −8.383E−14 |
| ficient (E) | | | | | | |
| 14th Coef- | −5.949E−10 | 1.179E−10 | 8.990E−09 | 2.187E−08 | 7.081E−17 | 7.125E−17 |
| ficient (F) | | | | | | |
| 16th Coef- | −3.083E−11 | 3.099E−11 | 0.000E+00 | 0.000E+00 | 5.785E−18 | 5.798E−18 |
| ficient (G) | | | | | | |
| 18th Coef- | −1.893E−12 | 1.413E−12 | 0.000E+00 | 0.000E+00 | 4.726E−19 | 4.729E−19 |
| ficient (H) | | | | | | |
| 20th Coef- | −2.316E−13 | −3.940E−13 | 0.000E+00 | 0.000E+00 | 3.855E−20 | 3.856E−20 |
| ficient (J) | | | | | | |
| | S10 | S11 | S12 | S13 | S14 | S15 |
| Conic | 0.000E+00 | 6.699E+00 | 0.000E+00 | 0.000E+00 | 0.000E+00 | 0.000E+00 |
| Constant (K) | | | | | | |
| 4th Coef- | 8.581E−03 | 7.902E−03 | 3.698E−02 | 1.399E−02 | −1.348E−02 | −8.409E−03 |
| ficient (A) | | | | | | |
| 6th Coef- | −3.316E−02 | −5.725E−02 | −5.215E−02 | −3.479E−03 | 1.791E−03 | 4.287E−05 |
| ficient (B) | | | | | | |
| 8th Coef- | 4.944E−02 | 5.637E−02 | 2.851E−02 | −2.562E−02 | 5.567E−05 | 2.846E−04 |
| ficient (C) | | | | | | |
| 10th Coef- | −3.432E−02 | −2.092E−02 | −2.040E−04 | 4.045E−02 | −8.293E−05 | −1.525E−04 |
| ficient (D) | | | | | | |
| 12th Coef- | 1.344E−02 | −1.047E−03 | −5.380E−03 | −2.693E−02 | 2.315E−05 | 3.478E−05 |
| ficient (E) | | | | | | |
| 14th Coef- | −2.819E−03 | 2.435E−03 | 1.181E−03 | 8.385E−03 | −1.592E−08 | −4.827E−08 |
| ficient (F) | | | | | | |
| 16th Coef- | 2.519E−04 | −4.514E−04 | 5.463E−05 | −1.013E−03 | −2.635E−08 | −5.806E−08 |
| ficient (G) | | | | | | |
| 18th Coef- | −8.330E−16 | −9.055E−16 | −8.989E−16 | −9.878E−16 | −4.262E−08 | −9.058E−08 |
| ficient (H) | | | | | | |
| 20th Coef- | −7.376E−17 | −7.861E−17 | −7.865E−17 | −8.460E−17 | 1.686E−18 | 1.684E−18 |
| ficient (J) | | | | | | |

Table 11 below list the values of the various quantities in Conditional Expressions 1 to 13.

TABLE 11

| | 1st | 2nd | 3rd | 4th | 5th |
|---|---|---|---|---|---|
| Quantity | Embodiment | Embodiment | Embodiment | Embodiment | Embodiment |
| BFL | 6.775 | 8.114 | 7.484 | 8.435 | 5.901 |
| TTL | 18.877 | 18.178 | 18.696 | 19.192 | 18.741 |
| Lf | 5.961 | 5.200 | 5.316 | 5.386 | 5.499 |
| Lr | 12.916 | 12.978 | 13.380 | 13.806 | 13.242 |
| f | 18.610 | 18.609 | 19.002 | 19.000 | 18.730 |
| fG1 | 11.370 | 12.251 | 12.231 | 13.579 | 13.373 |
| fG2 | −14.719 | −17.476 | −17.963 | −26.830 | −19.594 |
| PG1 | 0.088 | 0.082 | 0.082 | 0.074 | 0.075 |
| IMG HT | 7.150 | 7.150 | 7.150 | 7.150 | 7.150 |
| CA_G11 | 6.400 | 5.850 | 5.973 | 5.970 | 6.200 |
| CA_G21 | 2.965 | 2.901 | 2.914 | 3.064 | 3.061 |
| DG2 | 2.541 | 1.414 | 2.375 | 1.850 | 2.641 |
| RG1_S1 | 3.834 | 3.540 | 3.,693 | 6.470 | 5.311 |

Table 12 below lists the values of Conditional Expression 1 to 13. As can be seen from Table 12, all of the first to fifth embodiments of an optical imaging system according to the present disclosure satisfy all of Conditional Expressions 1 to 13.

TABLE 12

| Conditional | | | | | | |
|---|---|---|---|---|---|---|
| Expression | Quantity | 1st Emb. | 2nd Emb. | 3rd Emb. | 4th Emb. | 5th Emb. |
| 1 | PG1 | 0.088 | 0.082 | 0.082 | 0.074 | 0.075 |
| 2 | f/fG1 | 1.637 | 1.519 | 1.554 | 1.399 | 1.401 |
| 3 | Lr/f | 0.694 | 0.697 | 0.704 | 0.727 | 0.707 |
| 4 | Lr/TTL | 0.684 | 0.714 | 0.716 | 0.719 | 0.707 |
| 5 | CA_G21/CA_G11 | 0.463 | 0.496 | 0.488 | 0.513 | 0.494 |
| 6 | BFL/TTL | 0.359 | 0.446 | 0.400 | 0.440 | 0.315 |
| 7 | \|fG1/fG2\| | 0.772 | 0.701 | 0.681 | 0.506 | 0.683 |
| 8 | f/fG2 | −1.264 | −1.065 | −1.058 | −0.708 | −0.956 |
| 9 | RG1_S1/fG1 | 0.337 | 0.289 | 0.302 | 0.476 | 0.397 |
| 10 | Lf/Lr | 0.462 | 0.401 | 0.397 | 0.390 | 0.415 |
| 11 | DG2/TTL | 0.135 | 0.078 | 0.127 | 0.096 | 0.141 |
| 12 | fG1/TTL | 0.602 | 0.674 | 0.654 | 0.708 | 0.714 |
| 13 | f/CA_G11 | 2.908 | 3.181 | 3.181 | 3.183 | 3.021 |

An optical imaging system according to an embodiment of the present disclosure may capture a high-resolution image without a significant change in aberration due to autofocus adjusting.

While this disclosure includes specific examples, it will be apparent after an understanding of the disclosure of this application that apparent after an understanding of the disclosure of this application be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens group having a positive refractive power and comprising at least one lens;
a second lens group comprising a plurality of lenses; and
a reflective member disposed between the first lens group and the second lens group and comprising a reflective surface,
wherein the first lens group and the reflective member are configured to be rotatable together around two axes perpendicular to an optical axis of the first lens group and perpendicular to each other, and
the optical imaging system satisfies 1.3<f/fG1<1.8, where f is a total focal length of the optical imaging system, and fG1 is a focal length of the first lens group.

2. The optical imaging system of claim 1, further satisfying 0.07 [1/mm]≤PG1<0.1 [1/mm], where PG1 is a reciprocal of the focal length of the first lens group.

3. The optical imaging system of claim 1, further satisfying 0.6<Lr/f<0.8, where Lr is a distance along an optical axis of the optical imaging system from the reflective surface to an image plane of the optical imaging system.

4. The optical imaging system of claim 1, further satisfying 0.3<Lf/Lr<0.6, where Lf is a distance along an optical axis of the optical imaging system from an object-side surface of a lens closest to an object side of the optical imaging system among the at least one lens of the first lens group to the reflective surface, and Lr is a distance along the optical axis from the reflective surface to an image plane of the optical imaging system.

5. The optical imaging system of claim 1, further satisfying 0.6<Lr/TTL<0.8, where Lr is a distance along an optical axis of the optical imaging system from the reflective surface to an image plane of the optical imaging system, and TTL is a sum of a distance along the optical axis from an object-side surface of a lens closest to an object side of the optical imaging system among the at least one lens of the first lens group to the reflective surface, and a distance along the optical axis from the reflective surface to the image plane.

6. The optical imaging system of claim 1, further satisfying 0.2<BFL/TTL<0.5, where BFL is a distance along an optical axis of the optical imaging system from an image-side surface of a lens closest to an image plane of the optical imaging system among the plurality of lenses of the second lens group to the image plane, and TTL is a sum of a distance along the optical axis from an object-side surface of a lens closest to an object side of the optical imaging system among the at least one lens of the first lens group to the reflective surface, and a distance along the optical axis from the reflective surface to the image plane.

7. The optical imaging system of claim 1, further satisfying 0<DG2/TTL<0.2, where DG2 is a distance along an optical axis of the optical imaging system from an object-side surface of a lens closest to the reflective member among the plurality of lenses of the second lens group to an image-side surface of a lens closest to an image plane of the optical imaging system among the plurality of lenses of the second lens group, and TTL is a sum of a distance along the optical axis from an object-side surface of a lens closest to an object side of the optical imaging system among the at least one lens of the first lens group to the reflective surface, and a distance along the optical axis from the reflective surface to the image plane.

8. The optical imaging system of claim 1, further satisfying 0.3<CA_G21/CA_G11<0.6, where CA_G21 is an effective diameter of an object-side surface of a lens closest to the reflective member among the plurality of lenses of the second lens group, and CA_G11 is an effective diameter of an object-side surface of a lens closest to an object side of the optical imaging system among the at least one lens of the first lens group.

9. The optical imaging system of claim 1, further satisfying 2.8<f/CA_G11<3.2, where CA_G11 is an effective diameter of an object-side surface of a lens closest to an object side of the optical imaging system among the at least one lens of the first lens group.

10. The optical imaging system of claim 1, further satisfying 0.4<|fG1/fG2|<1, where fG2 is a focal length of the second lens group.

11. The optical imaging system of claim 10, wherein the second lens group has a negative refractive power.

12. The optical imaging system of claim 1, further satisfying-1.4<f/fG2<−0.6, where fG2 is a focal length of the second lens group.

13. The optical imaging system of claim 1, further satisfying 0.2<RG1_S1/fG1<0.6, where RG1_S1 is a radius of curvature of an object-side surface of a lens closest to an object side of the optical imaging system among the at least one lens of the first lens group.

14. The optical imaging system of claim 1, further satisfying 0.5<fG1/TTL<0.9, where TTL is a sum of a distance along an optical axis of the optical imaging system from an object-side surface of a lens closest to an object side of the optical imaging system among the at least one lens of the first lens group to the reflective surface, and a distance along the optical axis from the reflective surface to an image plane of the optical imaging system.

15. The optical imaging system of claim 1, wherein the at least one lens of the first lens group comprises a first lens and a second lens, and
at least one lens among the first lens and the second lens has a refractive index greater than 1.6, a convex object-side surface in a paraxial region thereof, and a concave image-side surface in a paraxial region thereof.

16. The optical imaging system of claim 15, wherein the first lens has a positive refractive power and a refractive index less than 1.55, and
the second lens has a negative refractive power.

17. The optical imaging system of claim 1, wherein a lens closest to an image plane of the optical imaging system among the plurality of lenses of the second lens group has a positive refractive power and a refractive index greater than 1.6, and
at least one other lens among the plurality of lenses of the second lens group, other than the lens closest to the image plane among the plurality of lenses of the second lens groups, has a refractive index greater than 1.6.

18. An optical imaging system comprising:
a first lens group having a positive refractive power and comprising at least one lens;
a second lens group comprising a plurality of lenses; and
a reflective member disposed between the first lens group and the second lens group and comprising a reflective surface,
wherein the first lens group and the reflective member are configured to be rotatable together around two axes perpendicular to an optical axis of the first lens group and perpendicular to each other, and
the optical imaging system satisfies 0.2<BFL/TTL<0.5, where BFL is a distance along an optical axis of the optical imaging system from an image-side surface of a lens closest to an image plane of the optical imaging system among the plurality of lenses of the second lens group to the image plane, and TTL is a sum of a distance along the optical axis from an object-side surface of a lens closest to an object side of the optical imaging system among the at least one lens of the first lens group to the reflective surface, and a distance along the optical axis from the reflective surface to the image plane.

19. The optical imaging system of claim 18, further satisfying 0.4<|fG1/fG2|<1, where fG1 is a focal length of the first lens group, and fG2 is a focal length of the second lens group.

20. The optical imaging system of claim 18, further satisfying 0.3<Lf/Lr<0.6, where Lf is a distance along an optical axis of the optical imaging system from an object-side surface of a lens closest to an object side of the optical imaging system among the at least one lens of the first lens group to the reflective surface, and Lr is a distance along the optical axis from the reflective surface to an image plane of the optical imaging system.

21. The optical imaging system of claim 18, further satisfying 0.5<fG1/TTL<0.9, where fG1 is a focal length of the first lens group.

22. An optical imaging system comprising:
a first lens group having a positive refractive power and comprising at least one lens;
a second lens group comprising a plurality of lenses; and
a reflective member disposed between the first lens group and the second lens group and comprising a reflective surface,
wherein the first lens group and the reflective member are configured to be rotatable together around two axes perpendicular to an optical axis of the first lens group and perpendicular to each other, and
the optical imaging system satisfies 0.3<CA_G21/CA_G11<0.6, where CA_G21 is an effective diameter of an object-side surface of a lens closest to the reflective member among the plurality of lenses of the second lens group, and CA_G11 is an effective diameter of an object-side surface of a lens closest to an object side of the optical imaging system among the at least one lens of the first lens group.

23. The optical imaging system of claim 22, further satisfying 0.07 [1/mm]≤PG1<0.1 [1/mm], where PG1 is a reciprocal of a focal length of the first lens group.

24. The optical imaging system of claim 22, further satisfying 0.2<RG1_S1/fG1<0.6, where RG1_S1 is a radius of curvature of the object-side surface of the lens closest to the object side of the optical imaging system among the at least one lens of the first lens group, and fG1 is a focal length of the first lens group.

25. The optical imaging system of claim 22, further satisfying 2.8<f/CA_G11<3.2, where f is a total focal length of the optical imaging system.
